(19) United States
(12) Patent Application Publication
(10) Pub. No.: US 2007/0285422 A1
(43) Pub. Date: Dec. 13, 2007

(54) Method for Separating Direct and Global Illumination in a Scene

(76) Inventors: Shree K. Nayar, New York, NY (US); Gurunandan Krishnan, New York, NY (US); Michael David Grossberg, New York, NY (US); Ramesh Raskar, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/624,016

(22) Filed: Jan. 17, 2007

Related U.S. Application Data
(60) Provisional application No. 60/760,059, filed on Jan. 18, 2006.

(51) Int. Cl. G06T 15/50

(52) U.S. Cl. 345/426

(57) ABSTRACT

A method and apparatus for determine an effect of direct and global illumination in a scene. A scene is illuminated with spatially varying illumination. A set of images is acquired of the scene, and a direct and global radiance in the set of images is determined.

### This application claims priority under 35 U.S.C. 119(e) from Provisional Application U.S. Ser. No. 60/760,059, filed Jan. 18, 2006, which application is incorporated herein by reference.

### STATEMENT OF GOVERNMENT INTERST

This invention was made in part with support from the U.S. Government Office of Naval Research under grant No. N000140510188.

### FIELD OF INVENTION

This invention relates generally to illuminating a scene, and more particularly to separating effects due to direct and global illumination components in the scene.

### BACKGROUND OF THE INVENTION

It is desired for provide a method for separating effects due to direct and global components of illumination in a scene, because each individual component conveys information about the scene that cannot be inferred from their combination.

For example, the direct illumination component gives a best indication of material properties in the scene. Therefore, the direct illumination component can be used to enhance a wide range of computer vision and computer graphics applications.

The global illumination component conveys complex optical interactions in the scene. It is the global illumination component that makes photorealistic rendering difficult. The global component could provide new insights into these optical interactions. That in turn could aid the development of more efficient rendering procedures.

Furthermore, separating the direct and global components can enable new types of image manipulations that are more faithful to the physical laws that govern light scattering.

One way to determine the effect of the global component is to illuminate each point in the scene independently while acquiring an image to determine the illumination contribution of the point to all other points. That method is valid from a theoretical standpoint. However, in a practical application, that method is prohibitively complex for complex scenes with a very large number of points.

The problem of separating the direct global illumination components in a scene has been addressed to a limited extent in the prior art. Conventional shape-from-intensity methods, such as photometric stereo do not account for global illumination due to inter-reflections, and hence, produce incorrect shape and reflectance estimates for scenes with concavities.

For Lambertian surfaces, the properties of the incorrect shape and reflectance produced by photometric stereo can be analyzed to recover the correct shape and reflectance, Nayer et al., “Shape from interreflections,” IJCV 6, 3, pp. 173-195, 1991. That recovery process implicitly separates the direct and global components of the scene. However, it is difficult to extend that method to non-Lambertian scenes with complex geometries.

In the case of the pure inter-reflections produced by an opaque surface, the direct and global components can be interpreted in a simple manner. The direct component is due to a single reflection at the surface, while the global component is due to multiple reflections.

A theoretical decomposition based on this interpretation estimates the inter-reflection contribution due to any given number of reflections, Seitz et al., “A theory of inverse light transport,” Proc. of ICCV, II: pp. 1140-1147, 2005. While the decomposition is applicable to surfaces with an arbitrary bidirectional reflectance distribution function (BRDF), that method for estimating the decomposition is also based on the Lambertian assumption. Moreover, that method requires a very large number of images because the method needs to determine the photometric coupling between all pairs of points in the scene.

In order to separate the illumination components of arbitrary scenes, it is necessary to consider more than just inter-reflections, and to be able to handle more complex phenomena, where the global radiance can be due in part to subsurface scattering in translucent objects, and volumetric scattering by participating media.

A general approach to the problem estimates the dependence of the light field in the scene on an arbitrary illumination field. That dependence can be expressed as a linear transformation, called a transport matrix, between the 4D incident light field (illumination) and the exitant light field (radiance).

Due to its enormous dimensionality, estimation of the transport matrix requires an extremely large number of images and illuminations, see Levoy et al., “Light field rendering,” Proc. of SIGGRAPH, ACM Press, pp., 31-42, 1996, and Gortler et al., “The lumigraph,” Proc. of SIGGRAPH, ACM Press, 43-54, 1996. For example, the image acquisition phase takes many hours, and the preprocessing of the images can take a similar amount of time or longer.

Several techniques are known for somewhat reducing the number of required images, by using coded illumination fields, Zongker et al., “Environment matting and compositing,” Proc. of SIGGRAPH, ACM Press, pp. 205-214, 1999, Debevec et al., “Aquiring the reflectance field of a human face,” Proc. of SIGGRAPH, ACM Press, pp. 145-156, 2000, Chuang et al., “Environment matting extensions: Towards a higher accuracy and real-time capture,” Proc. of SIGGRAPH, ACM Press, pp. 121-130, 2000, Lin et al., “Relighting with the reflected irradiance field: Representation, sampling and reconstruction,” IJVC 49, 2-3 (September), pp. 229-246, 2002, Peers et al., “Wavelet environment matting,” Eurographics Symposium on Rendering, ACM Press, pp. 157-166, 2003, Zhu et al., “Frequency-based environment matting,” Pacific Conf. on Comp. Graph. and Apps., pp. 402-410, 2004, Shim et al., “A statistical framework for image-based relighting,” Proc. of ICASSP, 2005, and Sen et al., “Dual photography,” ACM Trans. on Graph. 24, 3, pp. 745-755, 2005. However, those methods can still require up to hundreds of images. It is desired to separate the effect of direct and global illumination components without having to estimate the entire transport matrix. It is also desired to perform the separation using a very small number of acquired images, for example, a single image. Summary of the Invention The embodiments of the invention provide a method for separating the effect of direct and global illumination components in a scene from a set of images acquired of the scene illuminated by a source of electromagnetic radiation, e.g., light, infra-red, utlra-violet, etc. As used herein, illuminated generally means being exposed to the radiation. A method and apparatus determine an effect of direct and global illumination in a acene. A scene is illuminated with spatially varying illumination. The variance can be in intensity, phase or color. A set of images is acquired of the scene, and a direct and global radiance in the set of images is determined. The direct radiance at a point in the scene is due to direct illumination, and the global radiance is due to the illumination of the point by other points in the scene. The images can be acquired by an array of sensors arranged in a two-dimensional plane. The illumination can be varied spatially by a physical mask between a source of the illumination and the scene, e.g., in the form of a checkerboard pattern. A set of direct images and a set of global images can be generated from the direct and global radiance.

### BRIEF DESCRIPTION OF THE DRAWINGS

FIG. 1A is a block diagram of a system and method for separating the effect of direct and global illumination components according to an embodiment of the invention;

FIGS. 1B and 1C are spatially varying masks according to embodiments of the invention;

FIGS. 2A and 2B are block diagrams of high spatial frequency illumination in a scene according to an embodiment of the invention;

FIG. 3A is a block diagram of steps of a method for separating the effect of direct and global illumination according to an embodiment of the invention;

FIGS. 3B-3E are novel images produced according to the embodiments of the invention;

FIGS. 4A-4C are images of occluders according to an embodiment of the invention; and

FIG. 5 is a block diagram of a camera for separating illumination according to an embodiment of the invention.

### DETAILED DESCRIPTION OF THE PREFERRED EMBODIMENTS

The embodiments of our invention provide a method for separating the effect of direct and global illumination components in a scene from a set of images acquired of the scene illuminated by a source of electromagnetic radiation. As used herein, the ‘illuminating’ radiation can be at any wavelength in the electromagnetic spectrum, e.g., ultraviolet, visible light, infrared, radio, and the like.

The separate components can then be used to generate novel photorealistic images of the scene. As used herein, the meaning of the “set” is conventional, i.e., the set can include one or more images.

Scene

When the scene is illuminated by a source, a measurable radiance at each point in the scene is effectively due to direct and global illumination components. The direct radiance component is due to the direct illumination of the point by the source. The global radiance component is due to the illumination of the point by other points in the scene.

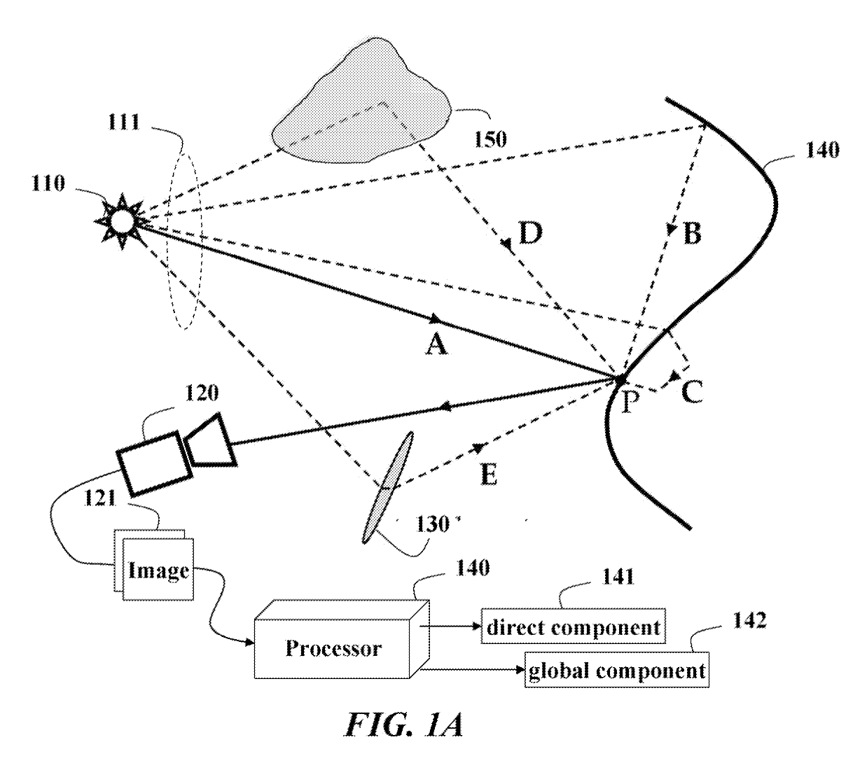

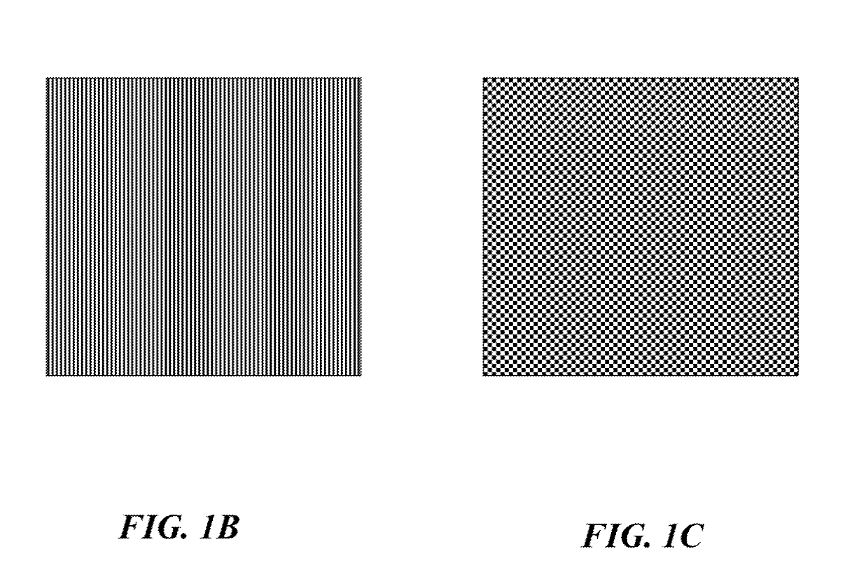

FIG. 1A shows a scene including a source 110 of direct illumination 111, a camera 120, a translucent surface 130, an opaque surface 140, and a participating medium 150. The camera 120 acquires a set of images 121 of the scene. The set of images 121 can be analyzed by a processor 140 executing a method according to the invention to determine the direct radiance component 141 and the global radiance component 142.

The camera includes an array of sensors arranged at an image plane. Each sensor can be considered a camera pixel, related to a corresponding image pixel. The sensors measure radiance at points in the scene. The radiance is due to the effect of incident illumination. The only requirement is that the sensors used to acquire images are compatible with the incident illumination. It should be noted that the sensors can be arranged in a 2D plane as in the camera, or in 3D as used for volumetric images, or as a sparse arrangement 1D sensors.

The source 110 can be a digital projector, e.g., a high intensity CRT, a LCD that uses LCD light gates, or a DLP projector that uses a DMD. In these cases, each ray corresponds to a single source illumination element, i.e., a projector pixel. Alternatively, the source can include infrared emitters, or emitters of electromagnetic radiation at other wavelengths.

A physical attenuating mask can be placed between the source and the sensors to spatially vary the illumination by moving the mask. For example, the mask can be in the form of a grating or a checkerboard pattern, as shown in FIGS. 1B and 1C.

A point P on the surface 140 receives direct illumination from the source 110 via a ray A. The rays B, C, D and E are received by the point P from other points in the scene. Together these rays contribute to the global component. The global illumination rays are caused by different physical phenomena that are common in the real world.

Ray B represents the inter-reflection of illumination between scene points. Ray C results from subsurface scattering within the medium beneath the surface. Ray D is due to volumetric scattering by the participating medium, e.g., fog, in the scene. Ray E is due to diffusion of illumination by the translucent surface.

Direct and Global Illumination

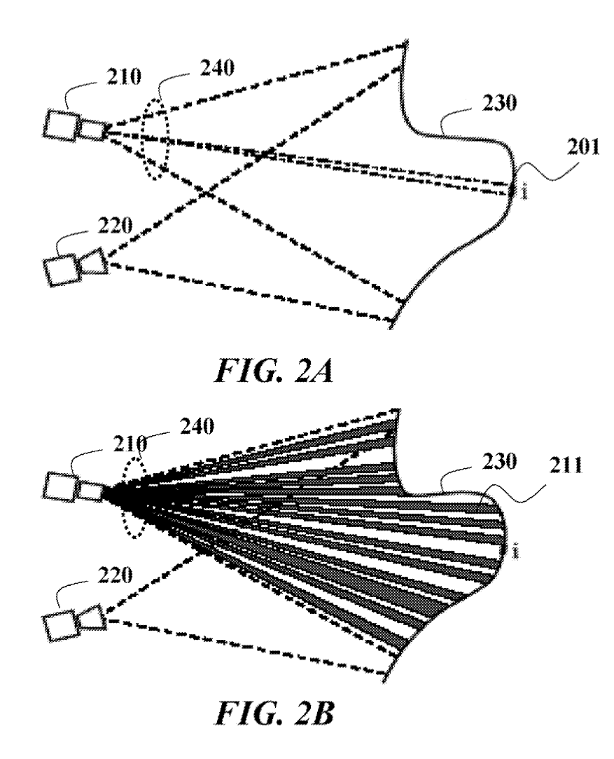

FIGS. 2A and 2B shows a scene including a source 210, a sensor (camera) 220 and an opaque surface 230.

Direct Illumination

The illumination source 210 generates a set of illumination rays 240. In response to the effect of the illumination, each point i 201 on the surface 230 can cause a significant scattering event in the direction of the camera 220 when illuminated by the source 210. The radiance of the surface point measured by the camera due to this scattering is L_{d}. The exact value of this radiance can be determined by the geometry and the BRDF at the surface point i.

In the practice, cameras and illumination sources have finite spatial resolutions. The direct component is an aggregate of all the scattering that occurs within the volume of intersection, between the fields of view of the camera pixel that measures the surface point, and the source element that illuminates the point, which can be arbitrary.

We assume generally that each camera pixel can measure, at most, one significant scattering event, i.e., two different source elements cannot produce a direct illumination component along a line of sight of the camera pixel.

Global illumination

The remaining radiance measured by the camera pixel is L_{g}. In computer graphics, this term is typically used to denote inter-reflections. That is, illumination received by a surface point after reflection by other scene points.

We use a more general definition. In addition to inter-reflections, the global illumination received by the surface point can be due to volumetric scattering, subsurface scattering, or even light diffusion by translucent surfaces, as shown in FIG. 1A.

The case of diffusion by a translucent surface works similarly to inter-reflections. In the case of volumetric scattering, the global component arises from the illumination of the surface point by illumination rays scattered from particles suspended in a participating medium, e.g., fog. In the case of subsurface scattering, the surface point receives illumination from other points within the surface medium.

The global component also includes volumetric and subsurface effects that can occur within the field of view of the camera pixel, but outside the volume of intersection between the fields of view of the camera pixel and the source element that produces a significant scattering event at the pixel. These are considered to be global effects as they are not significant scattering events caused by individual source elements.

Radiance Due to Effect of Illumination

In all cases, the total radiance L measured at the camera pixel is:
L=L_{d}+L_{g}. (1)

Illumination Source

As described above for one embodiment of the invention, we use a single camera and a single source. Although we prefer to use a point source to describe our separation method, this is not a strict requirement. We only require that each point in the scene is illuminated directly by at most one source element. In other words, the rays corresponding to the source elements should not intersect within the working volume used to perform the separation. Any source that satisfies this condition can be used to work the invention.

Varying Illumination Pattern

As used herein, we use illumination patterns that vary spatially. Preferably, the spatial variation has high frequency. For example, the checkerboard pattern of FIG. 1C where the “black” and “white” squares are about ten pixels or less on a side. The pattern can also vary over time, in intensity, and by phase. That is, some parts of the scene are illuminated while other parts are not at different times, or the other parts are illuminated with different intensities.

The opaque surface 230 has an arbitrary BRDF immersed in a non-scattering medium (air) so that the global component arises solely from inter-reflections. In this case, our analysis is applicable to the other phenomena such as subsurface scattering, and volumetric scattering.

The surface 230 is partitioned into N patches P. In essence, a ‘patch’ is a local group of points that can be measured by a single camera pixel. The source 110 illuminates directly M patches. Each of these M patches corresponds to a single camera pixel. We denote the radiance of the patch i measured by the camera pixel c as L[c,i]. The radiance has a direct radiance components L_{d}[c,i] and global radiance component L_{g}[c,i], such that
L[c,i]=L_{d}[c,i]⁺L_{g}[c,i].
The global radiance component at patch i, due to inter-reflections from all other surface patches can be written as:

$${L}_{g} [ c , i ] = {\sum }_{j ∈ P} A [ i , j ] L [ i , j ] , \qquad ( 2 )$$

where, P={j═1≦j≦N,j≠i}. The radiance L[i,j] is the radiance of patch j in the direction of patch i. The term A[i,j] incorporates the reflectance (BRGF) of i, as well as the relative geometric configuration of two patches i and j.

We can further decompose the global radiance component L_{g}[c,i] into two parts as
L_{g}[c,i]=L_{gd}[c,i]⁺L_{gg}[c,i],
where a first part L_{gd}[c,i] is due to the direct component of the radiance from all scene patches

$${L}_{gd} [ c , i ] = {\sum }_{j ∈ P} A [ i , j ] {L}_{d} [ i , j ] , \qquad ( 3 A )$$

and a second part L_{gg}[c,i] is due to the global component of radiance from all scene patches:

$${L}_{gg} [ c , i ] = {\sum }_{j ∈ P} A [ i , j ] {L}_{g} [ i , j ] . \qquad ( 3 B )$$

As shown in FIG. 2B, we assume that only a fraction α of the source elements illuminate, and that these illuminating elements are spatially distributed over the entire scene to produce the illumination pattern 211. The set of illuminated patches can be denoted as
Q={k|k∈N and lit(k)=1},
where the function lit indicates whether a particular patch is illuminated or not. Then, the two parts of the global radiance component L_{g}⁺become:

$$\begin{matrix}{L}_{gd} + [ c , i ] = {\sum }_{j ∈ Q} A [ i , j ] {L}_{d} [ i , j ] , & ( 4 A ) \\ and & \\ {L}_{gg} + [ c , i ] = {\sum }_{j ∈ P} A [ i , j ] {L}_{g} + [ i , j ] & ( 4 B )\end{matrix}$$

where the subscript “+” indicates a “lit” patch.

Note that L_{gd}[c,i] differs from L_{gd}[c,i], in that it is due only to the fraction of lit patches, rather than all the M patches that have a direct component, and hence, make a contribution. Therefore, if the geometry and reflectance term A[i,j], and the direct radiance component L_{d}[i,j] are smooth, with respect to the illumination pattern, we have:
L_{gd}⁺[c,i]=αL_{gd}[c,i]. (5)

A frequency domain analysis that makes the above relation valid is given below.

Now, let us consider the second part of the global radiance, L_{gg}^{+[c,i]. Because L}_{g}^{+[i,j] in Equations (4A) and (4B) is the result of higher orders of inter-reflection than L}_{gd}[c,i], it is even smoother, and hence less affected by the non-uniformity of the illumination.

However, the second part is directly proportional to an average power of the illumination, which is reduced in the case of the spatially varying illumination pattern. Therefore,
L_{g}⁺[i,j]=αL_{g}[i,j],
and we obtain:
L_{gg}⁺[c,i]=αL_{gg}[c,j]. (6)

Minimum Spatial Frequency of Illumination

For any realistic scene, it is difficult to derive a closed-form expression for the minimum spatial frequency of the illumination needed to perform the separation. This is because the terms A[i,j] and L_{d}[i,j] in Equation (3) are complicated functions of the surface BRDF and geometry. However, some insights can be gained by viewing these terms as continuous functions and analyzing the terms in frequency domain. Without loss of generality, we assume the scene is 1D. Let x and y be the continuous versions, defined on the scene surface, of the discrete parameters i and j, respectively. Because we are considering a single surface point x, we can drop this parameter. Then, from Equations (3A) and (3B), we have:

$${L}_{gd} = \int A ( y ) {L}_{d} ( y ) ⅆ y .$$

Let A(y) and Ld(y) have maximum frequencies of ω_{A} and ω_{L}, respectively. Because the product A(y)L_{d}(y) in the spatial domain corresponds to a convolution in the frequency domain, the product has a maximum frequency of ω_{A}+ω_{L}.

If our goal were to completely reconstruct the function A(y)L_{d}(y), then we need to sample with a minimum (Nyquist) frequency of 2(ω_{A}+ω_{L}). However, we are interested in L_{gd}, which is an integral over A(y)L_{d}(y), and hence equals its zero-frequency (DC) component.

To ensure this DC component is not aliased, the signal is sampled with at least half the Nyquist frequency. Therefore, we need to sample A(y) and L_{d}(y) with a minimum illumination frequency of (ω_{A}+ω_{L}) to obtain an accurate estimate of the radiance L_{gd}.

Global illumination guarantees that the second part L_{gg} in Equation (3B) is smoother than the first part L_{dg} in Equation (3A). Therefore, the above illumination frequency is adequate to obtain an accurate estimate of the radiance L_{gg}.

Radiance Separation Method

We acquire a set of images of the scene, e.g., two images. While acquiring the first image L⁺, the scene is illuminate by a fraction α of the source elements, and while acquiring the second image L⁻, the scene is illuminated by a complementary fraction 1−α of the source elements.

If the patch i is illuminated directly by the source in the first image L⁺, then the patch i is not illuminated by the source in the second image L⁻.

Thus, we obtain
L⁺[c,i]=L_{d}[c,i]+αL_{g}[c,i], and L⁻[c,i]=(1−α)L_{g}[c,i]. (7)

Therefore, if we know the fraction α, we can determine the direct and global radiance components at each camera pixel from just two images. That is, by measuring the radiance we have separated the effect of the direct and global illumination components in the scene.

Source Limitations

Thus far, we assume that when a source element is not illuminating, the element does not generate any light. In the case of a projector, for example, this is seldom completely true. If we assume the intensity of a deactivated (non-illuminating) source element is a fraction b of an activated (illuminating) element, then the above expressions can be modified as:
L⁺[c,i]=L_{d}[c,i]⁺αL_{g}[c,i]^{+b}(1−α) L_{g}[c,i],
L⁻[C,i]=bL_{d}[c,i]⁺(1−α)L_{g}[c,i]⁺αbL_{g}[c,i]. (8)

Again, if α and b are known, then the separation can be done using just two images. Note that if a is either close to 1 or 0, then the scene is illuminated very sparsely as measured in one of the two images. If we want to maximize the spatial frequency of the illumination in both images, then α=½. In this case, we obtain:

$$\begin{matrix}{L}^{+} [ c , i ] = {L}_{d} [ c , i ] + ( 1 + b ) \frac{{L}_{g} [ c , i ]}{2} , & ( 9 ) \\ {L}^{-} [ c , i ] = {bL}_{d} [ c , i ] + ( 1 + b ) \frac{{L}_{g} [ c , i ]}{2} . & \end{matrix}$$

Based on the above analysis, we provide a variety of separation methods. In each case, we measure a set of intensity values at each camera pixel (sensor) and use the radiances Lₘₐₓ and Lₘᵢₙ to denote the maximum and minimum of these intensity values.

If two images taken with α=½, L⁺≧L⁻, then Lₘₐₓ=L⁺, and Lₘᵢₙ=L⁻.

General Considerations

While we have used a simple scene with just inter-reflections to describe our separation method, it is applicable to a wide range of applications. The direct illumination component can effect diffuse and specular reflections. The global component can arise from not just inter-reflections but also from volumetric and subsurface scattering. In the presence of these scattering effects, a three-dimensional surface patch j in the above Equations represents voxels of intersection between the fields of view of camera pixels and source elements that are distributed in 3D space, rather then 2D surface patches.

In the case of volumetric scattering, as described above, two effects are measured by the global radiance component. The first effect is the illumination of each surface point by the participating medium. This effect works like inter-reflections, and hence is included in the measured global radiance component. The second effect is the intensity of the participating medium within the pixel's field of view. Consider the entire set of source rays that pass through the line of sight of a single camera pixel. In the first image, a fraction α passes through the line of sight, and in the second image a fraction (1−α) of the rays pass through the line of sight.

Therefore, if the illumination frequency is sufficient, even if the medium is non-homogeneous, the second effect is also included in the measured global radiance component. In the case of subsurface scattering, the direct radiance component is effected by the BRDF of the surface interface, while the global radiance component is produced by the BSSRDF of the surface medium.

Separation Methods and Novel Images

We now describe several methods that use spatially varying illumination patterns to perform the direct and global separation. In addition, we describe how separated direct and global images can be used to generate novel images of the scene.

Checkerboard Illumination Shifts

As described above, a spatially varying illumination pattern and its complementary pattern are sufficient to obtain the direct and global components of the scene. Unfortunately, it is difficult to obtain such ideal patterns using a conventional digital projector. Due to light leakages within the projector optics and custom image processing in the projector, the active and inactive elements have intensity variations.

To overcome these problems, we can take a larger number of images than theoretically required. For example, we can us a checkerboard pattern, see FIG. 1C, with squares that are 8×8 pixels in size, and shift the pattern by three pixels five times in each of the two dimensions to acquire asset of twenty-five images.

Generating Direct and Global Images

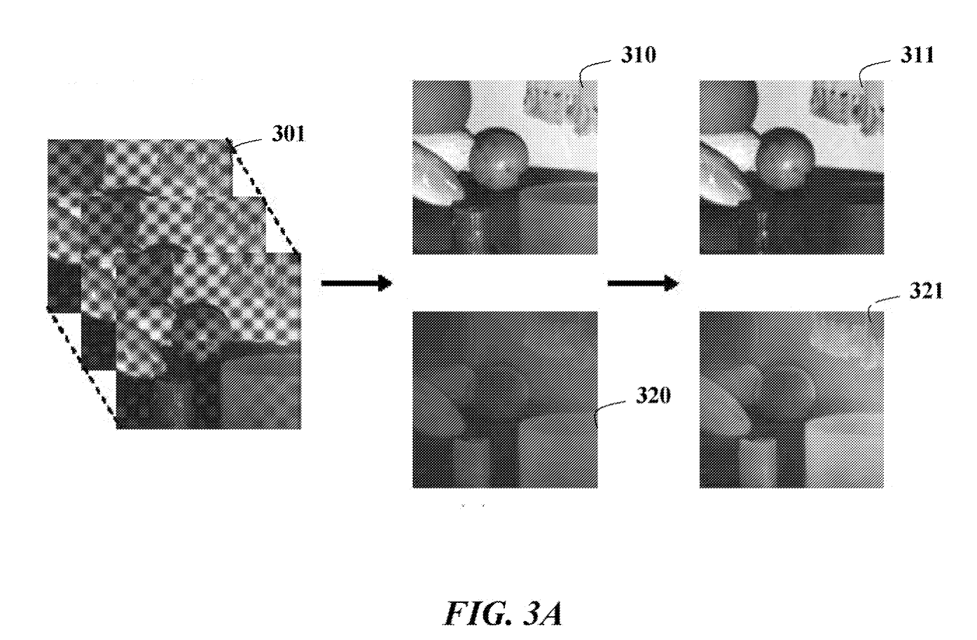

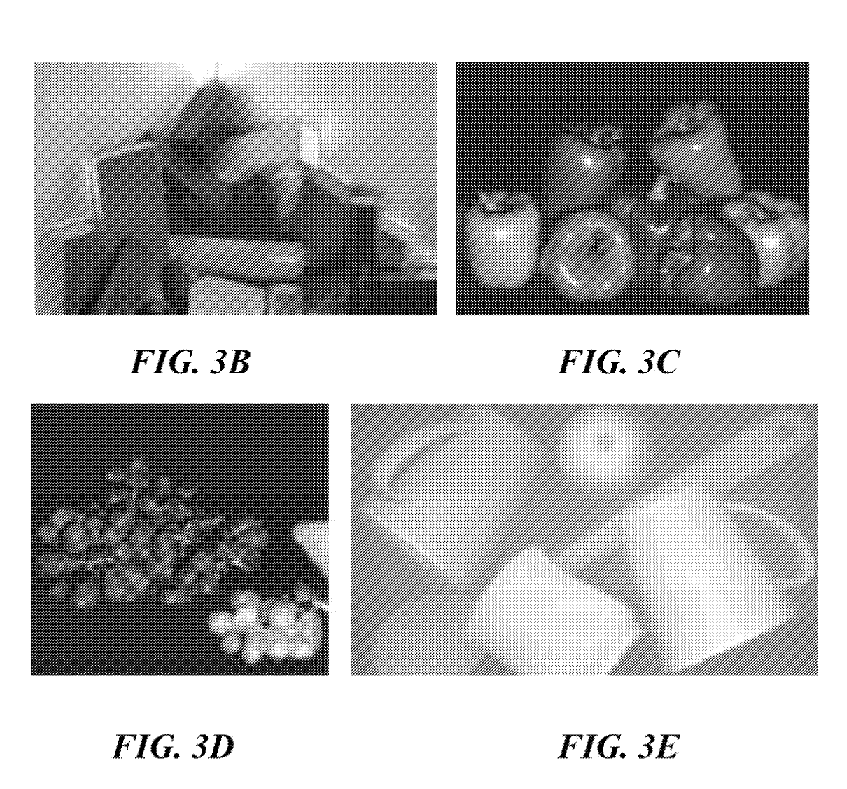

FIG. 3A shows the steps for generating a set of direct images and a set of global images using the above described checkerboard illumination pattern. As before, each set can include one or more images. The direct image shows the effect of the direct illumination, and the global image shows the effort of the global illumination.

The direct and/or the global image can then be combined with other images of the scene to provide novel images. The combining can be weighted according to intensities in the images.

FIG. 3A shows the separation steps. A set of images 301 are acquired by the camera. The images correspond to a small part of the scene. At each pixel, a minimum image (Lₘₐₓ) 310 and minimum image (Lₘᵢₙ) 320 are determined. The maximum and minimum images are then used to generate the direct image 311, and the global image 321, using Equation (9). Because the radiance is in response to the illumination, the effect of the direct and global illumination components can easily be observed in the images 311 and 321.

FIGS. 3B-3E shows examples of how novel images of a scene can be determined from the direct and global images. In the case of the wooden blocks in FIG. 3B, the novel image is a differently weighted sum of the two component images. The global component is given three times the weight of the direct component. Although such an image appears unrealistic and is impossible from a physical standpoint, it is interesting as it emphasizes the optical interactions between objects in the scene.

In the novel image of the peppers in FIG. 3C, the peppers have been given different colors by changing their hues in the global image and recombining with the direct image, which includes the specular highlights that have the color of the source.

The same process is used to generate the novel image 3D of the grapes in FIG. 3D. In comparison with the peppers, the direct component of the grapes includes both specular and diffuse reflections from the surface.

FIG. 3E shows items in a kitchen sink filled with a ‘milky’ liquid. The dark regions of the global image were used to estimate the brightness Lₘ of the liquid. Lₘ is assumed to be constant over the scene and is removed from the global image to obtain the radiance L_{gm} of the objects due to illumination by the liquid. The ratios of brightnesses in the direct image L_{d} and the milky liquid illumination image L_{gm} are tabulated. Then, the direct images of two other objects (fruit and pot) are separately acquired, and their milk illumination images are determined using the tabulated ratios. The L_{d}, Lₘ and L_{gm} components of these new objects are then added, and the objects are inserted into the scene image. Notice how the inserted objects include not only the effects of scattering by the milk but also secondary illumination by the milky liquid.

Source Occluders

As described above, we use a digital projector to generate the spatially varying illumination patterns. In the case of a simple uncontrollable light source, such as the sun, occluders of various kinds can be used spatially varying shadows on the scene.

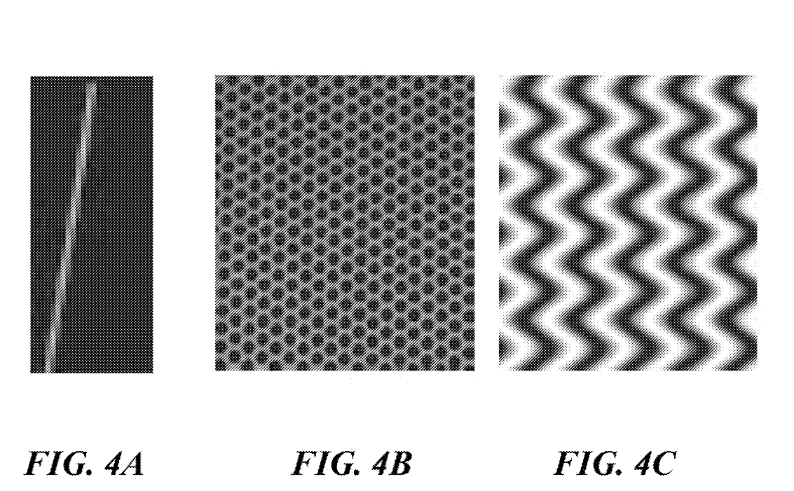

For example, FIG. 4A shows a line occluder, such as the stick, that can be swept across the scene while a set of images are acquired. If the occluder is thin, its shadow occupies a small part of the scene, and hence we can assume α=1 in Equation (8). Furthermore, if the scene point lies within the umbra of the shadow, then there is no direct contribution due to the source, and hence b=0 in Equation (8).

Let Lₘₐₓ and Lₘᵢₙ be the maximum and minimum radiance measured at a scene point in the set of images acquired while sweeping the occluder. Then, Lₘₐₓ=L_{d}⁺L_{g}, Lₘᵢₙ=L_{g}, and the two radiance component can be separated. In the case of a line occluder, the image sequence is long enough to ensure that all the scene points have been subjected to the umbra of the shadow.

As shown in FIG. 4B, the process can be made much more efficient by using a more complex mesh occluder, such as a 2D grid of circular holes. It should be understood, that the structure of the pattern does not need to be known. In the case, only a small circular motion of the occluder is needed to ensure that all the points are in and out of shadow. If a fraction α of the grid is occupied by the holes, then we have Lₘₐₓ=L_{d}⁺αL_{g}, and Lₘᵢₙ=αL_{g}.

Other Varying Patterns

So far, we have described two-valued illumination patterns (or shadows). However, our separation method is applicable to other illumination patterns as well. For instance, the method can be incorporated into conventional structured-light range finders that use coded illumination patterns.

In the case of binary coded patterns, some of the patterns have high frequency stripes. The corresponding images can be used to estimate the direct and global components. In the case of a projector, any positive illumination function can be generated.

A convenient class of functions is based on the sinusoidal function as shown in FIG. 4C. By using a pattern that varies over space and/or time, as a sinusoid at each projector pixel, the separation can be done using just three patterns. In the first pattern, the intensities of all the projector elements are randomly generated using a uniform distribution between 0 and 1. Thus, the scene is illuminated with half the power of the projector to produce a global radiance component of L_{g}=2 at each scene point.

Let the intensity of a given projector element be α=0.5+0.5 sin ∅, where 0≦∅≦2π. Two more illumination patterns are generated by changing the phases of the sinusoids of all the pixels by, say, 2π/3 and 4π/=3.

Note that ∅ gives us the correspondence between camera pixels and projector elements. Hence, the 3D structure of the scene can be determined as well.

In the above example, we used a random first pattern and vary the intensity of the illumination as a sinusoid. Alternatively, a pattern can be generated that is sinusoidal with a frequency in one direction, and the phase of the sinusoid can be varied with the frequency in the order direction. An example of such a function in sin(x+sin y). The phase variation along the y dimension is only used to ensure that the illumination has high spatial frequencies along both spatial dimensions. If three images of the scene are acquired using this pattern and two shifted versions of the pattern, where the shifts are in the x dimension and are known, we obtain three Equations as in the previous case and L_{d}, L_{g} and ∅ can be determined.

Separation using a Single Image

Thus far, we have described methods that can produce separated images at the full resolution of the set of acquired images. The direct and global images can be determined at a lower resolution using a single acquired image when the effect of the illumination is substantially smooth over small local regions in a scene.

Consider a scene illuminated by a binary that is high frequency in the spatial domain, e.g., a checkerboard pattern. We filter each color channel of the acquired image to find local peaks and valleys. This is done by assigning a pixel a “maximum” or “minimum” label if the intensity of the pixel is the maximum or minimum within a relatively small, and local n×m window centered around the pixel.

The intensity at these peaks and valleys are then interpolated to obtain full resolution Lₘₐₓ and Lₘᵢₙ images. If we assume that the separation results are to be computed at 1=k of the resolution of the acquired image, then we determine Lₘₐₓ and Lₘᵢₙ images at this lower resolution by averaging their values within k×k blocks in the high resolution images. After this is done, L_{d} and L_{g} are determined using Equation (8).

Applications

The separation methods according to the invention can be used in a number of applications.

Digital Photography

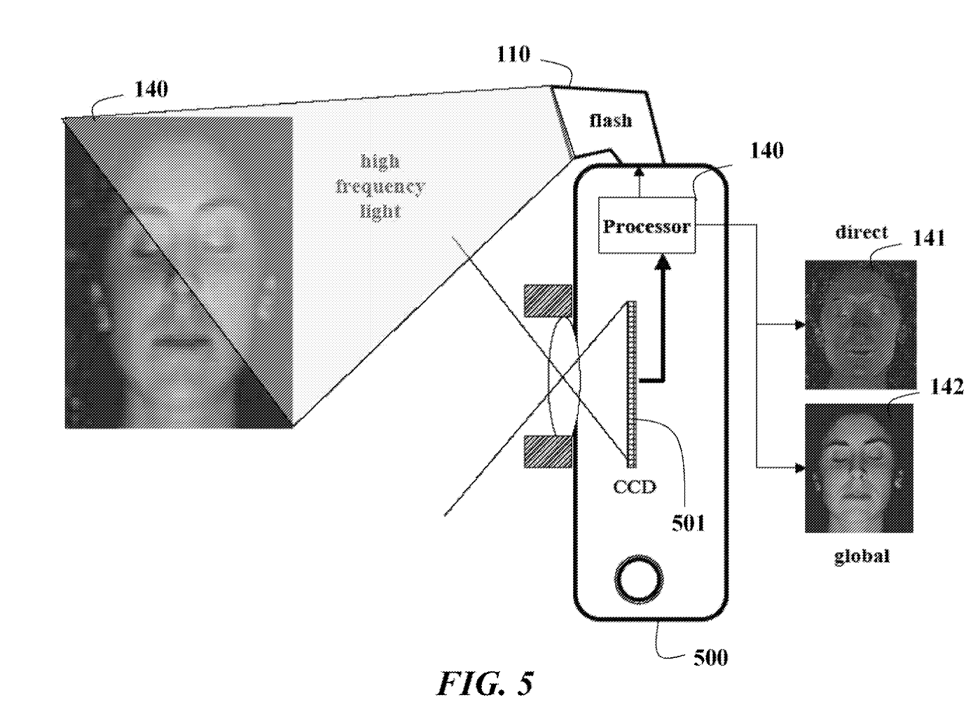

As shown in FIG. 5, the separation can be done using a digital or film camera 500 including a CCD sensor 501 by modifying the direct light source (flash unit) 110 of the camera. Conventionally, the camera flash is a single isotropic light source that illuminates everything in the field of view of the camera. Our flash unit can project a high spatial frequency illumination pattern, as described above. This can be done either using a projector like device as the flash or by using a customized source. In the case of the projector like device, the illumination patterns can be generated and varied in the manner described in our preferred embodiment.

In the case of a customized source, the source can include a set of light sources, e.g., LEDs, that are slightly displaced with respect to each other. In front of this set of sources is placed an optical mask having a spatial transmittance function that is the same as the intended high spatial frequency illumination pattern. When a single source is activated, the desired illumination pattern is projected onto the scene. By activating the set of source in sequence, the projected pattern is shifted with respect to the scene because the individual sources are at different locations.

For example, an optical mask with stripes can be used. If the stripes are in the vertical direction as shown in FIG. 1B, the sources are displaced with respect to each other in the horizontal direction. Sequential activation of the sources results in shifting of the projected striped illumination in the horizontal direction. An image is captured for each of the shifts and the set of captured images will guarantee that each point in the scene is directly lit in at least one of the images and the high frequency of the illumination will guarantee that the global illumination received by each point will remain constant with respect to the shifts.

Another approach is to use a mechanical technique to spatially shift the high frequency illumination. In this case, a single source can be placed behind a high frequency optical mask. The mask is then moved physically to cause the projected illumination to shift with respect to the scene. This approach is the same as the use of occluders to generate high frequency shadows described above. The type of motion that is applied to the mask depends on the type of pattern that is imprinted on the mask. For instance, a high frequency stripe pattern can be translated and a two-dimensional pattern can be rotated.

When the separation method is incorporated into a camera, the camera can produce direct and global images of any scene. After this is done, novel images of the scene can be computed, after the scene has been photographed, using the novel image generation methods described above.

Medical Imaging

In most conventional medical imaging applications, the media/objects, e.g., patients, involved produced subsurface and/or volumetric scattering effects. This is a serious problem as these effects tend to diminish the clarity (contrast) of the acquired images.

Our separation method can resolve these effects. As an example, images of human skin are used by dermatologists to diagnose skin diseases, and by cosmetologists and cosmetic surgeons to study various skin features, e.g., wrinkles, pores, and freckles. The conventional approach is to simply illuminate the skin area of interest and acquire a high resolution image. The resulting image includes the surface reflection from the oils and lipids on the skin as well as the subsurface scattering effects due to tissues beneath the surface of the skin.

Using the separation method, high quality direct and global images of the skin can be obtained. The direct image includes the specular reflection of light due to the oils and lipids on and in the skin. The direct image appears metallic and reveals the micro-geometry of the scene in a way that is not possible to capture in a conventional image, see FIG. 5. In addition, the direct image includes any surface imperfections such as dry skin and scars. In contrast to the oils and lipids of the skin, these imperfections produce mainly diffuse reflections and are clearly visible in the direct image.

In contrast, the global image reveals, with greater clarity, all the optical events that take place beneath the surface of the skin. For instance, the veins and variations in tissue thicknesses are visible in this image. In addition, disease cells that have different properties from healthy skin cells may also appear with greater clarity.

For these reasons, a dermatologist, cosmetic surgeon, or a cosmetologist can greatly benefit from the separation method described herein. While a cosmetologist may apply the separation method to the face of a patient, a dermatologist may apply the method to a small skin region on the body that appears to be affected by a medical condition.

Distinguishing Real from Fake Objects

The separation method can be effective in detecting the authenticity of an object. Consider fruits and vegetables bought in a grocery store versus plastic versions of the fruits used as displays in restaurants. While the fake versions can appear very realistic in appearance, it turns out that their direct and global components tend to be quite different. This is because the subsurface scattering effects produced by the synthetic materials (plastic for example) used to create the object can be quite different from the subsurface effects produced by organic materials that the real object is made of. As a result, the separation method can serve as a very fast and effective method for inspecting the authenticity of objects.

Underwater Imaging

It is well known that underwater imaging systems are adversely affected by volumetric scattering effects. Particle suspended in water can produce very strong scattering effects that make it very difficult to image surfaces that are distant from the source and the camera.

There are two effects at work here. The first is that the water attenuates light as it passes through it. The light is first attenuated as it makes it way from the source to the scene point and then the light is attenuated again as it travels from the scene point to the camera. This attenuation process serves to dim the radiances of the scene points. In addition, the water itself behaves like a source of light. That is, light received from the source by the water impurities is scattered in the direction of the camera. This causes the water itself to serve as a light source. The brightness of the water reduces the contrast of the image, thereby making the already attenuated scene of interest even more difficult to image.

As described above, in the case of a participating medium (such as water), the separation method produces a direct image that is devoid of the light scattered by the medium. The direct image looks like an image of the scene taken in a clear medium, except that it is dimmer due to the attenuation. If a high dynamic range camera is used, this dim image can be enhanced to obtain a clear image of the scene of interest.

Imaging Through Bad Weather

The volumetric scattering phenomenon observed in the case of water is also observed in the case of bad weather conditions such as clouds, fog, mist and haze. In all of these cases, there is scattering water vapor between the illumination source and scene, and the same scattering effects are observed: attenuation of the scene due to the medium and the brightening of the medium. Therefore, in is case as well, the direct image is an image of the scene that appears like on taken on a clear day.

Art History

The separation method can be use for art restoration and art historians. In the case of the painting, the direct and global images are expected to reveal in greater detail the layers of materials used to create the painting. In the case of sculptures, the direct image shows the finish of the surface (roughness, chisel, marks, etc.), while the global image captures the strong subsurface scattering effects (in the case of marble, for instance).

Effect of the Invention

The invention provides a method for separating the effect of direct and global illumination components of a scene lit by a light source. The method is applicable to complex scenes with a wide variety of global illumination effects.

To our knowledge, this is the first time that the effect of direct and global illumination in arbitrarily complex real-world scenes has been measured. Images obtained in this manner reveal a variety of non-intuitive effects and provide new insights into the optical interactions between objects in a scene.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We Claim:

1. A method for determining an effect of direct and global illumination in a scene, comprising:
illuminating a scene with spatially varying illumination;
acquiring a set of images of the scene;
determining a direct radiance in the set of images; and
determining a global radiance in the set of images.

2. The method of claim 1, in which the illumination is visible light.

3. The method of claim 1, in which the illumination is infrared radiation.

4. The method of claim 1, in which the direct radiance at a point in the scene is due to direct illumination, and the global radiance is due to the illumination of the point by other points in the scene.

5. The method of claim 1, in which the images are acquired by an array of sensors arranged in a two-dimensional plane.

6. The method of claim 1, in which the images are acquired by a three-dimensional array of sensors.

7. The method of claim 1, in which the images are acquired by an array of one-dimensional sensors.

8. The method of claim 1, in which the illumination is generated by a projector.

9. The method of claim 1, in which the illumination is generated by a point source.

10. The method of claim 1, in which the illumination is varied spatially by a physical mask between a source of the illumination and the scene.

11. The method of claim 1, in which the illumination is varied according to a checkerboard pattern.

12. The method of claim 1, in which an intensity of the illumination is varied spatially.

13. The method of claim 1, in which a phase of the illumination is varied spatially.

14. The method of claim 1, further comprising:
generating a set of direct images from the direct illumination; and
generating a set of global images from the global radiance.

15. The method of claim 14, further comprising:
combining the set of direct images and the set of global images to produce novel images.

16. The method of claim 15, in which the combining is weighted according to intensities in the images.

17. The method of claim 1, in which the images are acquired by a sparse array of discrete sensors.

18. The method of claim 14, in which the combining is weighted according to color values in the images.

19. The method of claim 1, in which the illumination is varied by moving a linear occluder between a source of the illumination and the scene.

20. The method of claim 1, in which the illumination varies spatially according to a sinusoidal function.

21. The method of claim 1, in which the set of images includes a single image.

22. The method of claim 1, in which the set of images acquired of skin to resolve subsurface scattering effects.

23. The method of claim 1, in which the set of images are acquired of objects to resolve authenticity of the objects.

24. The method of claim 1, in which the set of images are acquired of objects under water.

25. The method of claim 1, in which there is an illumination scattering medium between a source of illumination and the scene.

26. The method of claim 1, in which the global radiance is due in part to subsurface scattering of the spatially varying illumination.

27. The method of claim 1, in which the global radiance is due in part to volumetric scattering by a participating medium in the scene.

28. The method of claim 1, in which the global radiance is due in part to diffusion of spatially varying illumination by a translucent surface in the scene.

29. The method of claim 1, in which there is water vapor between a source of illumination and the scene.

30. The method of 1, in which the direct radiance and the global radiance are determined from a maximum intensity and minimum intensity at each point in the scene while spatially varying illumination.

31. An apparatus for determining an effect of direct and global illumination in a scene, comprising:
a source configured to illuminate a scene with spatially varying illumination;
a sensor configured to acquire a set of images of the scene;
means for determining a direct radiance in the set of images; and
means for determining a global radiance in the set of images.

32. The apparatus of claim 31, in which the illumination is visible light.

33. The apparatus of claim 32, in which the direct radiance at a point in the scene is due to direct illumination, and the global radiance is due to the illumination of the point by other points in the scene.

34. The method of claim 31, in which the light source is a flash unit and the sensor is a camera.

35. The apparatus of claim 31, in which the illumination is varied spatially by a physical between a source of the illumination and the scene.

36. The apparatus of claim 31, further comprising:
means for generating a set of direct images from the direct illumination; and
means for generating a set of global images from the global radiance.

37. The apparatus of claim 36, further comprising:
means for combining the set of direct images and the set of global images to produce novel images.

38. The apparatus of claim 37, in which the combining is weighted according to intensities in the images.
